(19) United States
(12) Patent Application Publication
(10) Pub. No.: US 2011/0044703 A1
(43) Pub. Date: Feb. 24, 2011

(54) IMAGE FORMING APPARATUS FOR MANAGING REPLACEMENT COMPONENTS

(75) Inventor: Hiroyuki Fuse, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/858,015

(22) Filed: Aug. 17, 2010

Related U.S. Application Data
(60) Provisional application No. 61/236,233, filed on Aug. 24, 2009.

(51) Int. Cl. G03G 15/00

(52) U.S. Cl. 399/12

(57) ABSTRACT

According to one embodiment, an image forming apparatus includes: a code storing section configured to store a valid authentication code; a history storing section configured to store peculiar information of a used replacement component; a code determining section configured to determine, when an unused replacement component is replaced, whether a permission authentication code is valid; and a cartridge determining section configured to determine whether the unused replacement component is a regular replacement component.

### CROSS-REFERENCE TO RELATED APPLICATION

This application is based upon and claims the benefit of priority from Provisional U.S. Application 61/236233 filed on Aug. 24, 2009, the entire contents of which are incorporated herein by reference.

### FIELD

Embodiments described herein relate generally to an image forming apparatus configured to detect whether a new replacement component is a regular replacement component and eliminate an irregular replacement component.

### BACKGROUND

An image forming apparatus such as a copying machine and a printer includes, for example, a detachable toner cartridge or process cartridge. When a toner in the toner cartridge is exhausted or the process cartridge exhausts a life, a manufacturer or a support department detaches the toner cartridge, the process cartridge, or the like from an apparatus main body and replaces the toner cartridge, the process cartridge, or the like with a new replacement component.

However, if the replacement component is not a regular replacement component authenticated by the manufacturer, for example, if the replacement component is a component obtained by refilling a toner in a used toner cartridge or an imitation component, a function or print performance suitable for the image forming apparatus cannot be obtained. If an imitation irregular replacement component is used, it is likely that a trouble due to the irregular replacement component such as a failure of the image forming apparatus or a fall in print performance occurs.

Therefore, there is a demand for development of an image forming apparatus configured to disable, even if an imitation irregular replacement component is mounted on the image forming apparatus when a component is replaced with a new replacement component, use of the mounted irregular replacement component. There is also a demand for development of an image forming apparatus configured to enable use of only a regular replacement component authenticated by a manufacturer and make it possible to obtain safety and high performance of the apparatus.

### DESCRIPTION OF THE DRAWINGS

FIG. 1 is a schematic diagram of a color copying machine;

FIG. 2 is a partial perspective view of a toner cartridge;

FIG. 3 is a schematic block diagram of a control system configured to mainly determine propriety of the toner cartridge;

FIG. 4 is a flowchart for explaining management of determination whether an unused toner cartridge is a regular replacement component;

FIG. 5 is a flowchart for explaining management of check of pairing;

FIG. 6 is a flowchart for explaining management of determination whether an unused toner cartridge is a regular replacement component;

FIG. 7 is a flowchart for explaining management of determination whether an unused toner cartridge is a regular replacement component;

FIG. 8 is a flowchart for explaining management of determination whether an unused toner cartridge is a regular replacement component;

FIG. 9 is a flowchart for explaining management of determination whether an unused toner cartridge is a regular replacement component;

FIG. 10 is a flowchart for explaining management of determination whether an unused toner cartridge is a regular replacement component;

FIG. 11 is a flowchart for explaining management of determination whether an unused toner cartridge is a regular replacement component; and

FIG. 12 is a flowchart for explaining management of determination whether an unused toner cartridge is a regular replacement component.

### DETAILED DESCRIPTION

In general, according to one embodiment, an image forming apparatus includes: a code storing section configured to store a valid authentication code; a history storing section configured to store peculiar information of a used replacement component; a code determining section configured to determine, when an unused replacement component is replaced, whether a permission authentication code is valid; and a cartridge determining section configured to determine whether the unused replacement component is a regular replacement component.

Embodiments are explained below.

### FIRST EMBODIMENT

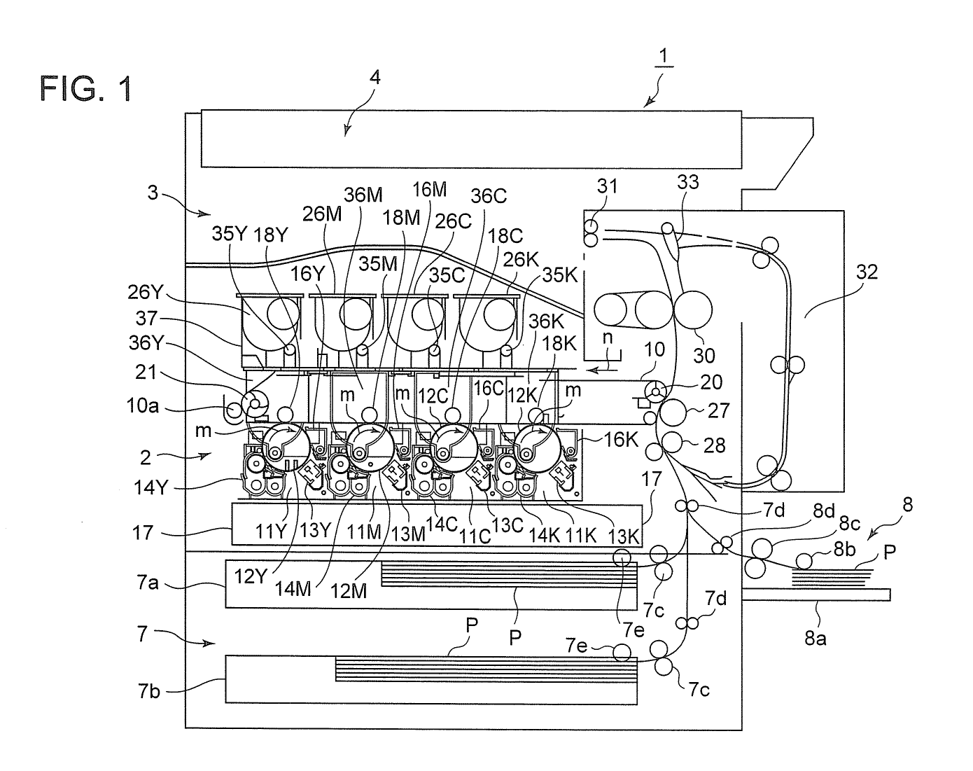

A color copying machine 1 as an image forming apparatus shown in FIG. 1 includes a printer section 2 configured to form an image, a paper discharge section 3 in which sheets P discharged from the printer section 2 are accumulated, a scanner section 4 configured to read a document image, a paper feeding device 7 configured to feed the sheets P one by one, and a bypass paper feeding device 8.

The printer section 2 includes four image forming stations 11Y, 11M, 11C, and 11K arranged in parallel along the lower side of an intermediate transfer belt 10. The image forming stations 11Y, 11M, 11C, and 11K respectively include photoconductive drums 12Y, 12M, 12C, and 12K. The image forming stations 11Y, 11M, 11C, and 11K respectively form toner images of Y (yellow), M (magenta), C (cyan) and K (black) on the photoconductive drums 12Y, 12M, 12C, and 12K.

The photoconductive drums 12Y, 12M, 12C, and 12K rotate in an arrow m direction. The image forming stations 11Y, 11M, 11C, and 11K respectively include, around the photoconductive drums 12Y, 12M, 12C, and 12K, chargers 13Y, 13M, 13C, and 13K, developing devices 14Y, 14M, 14C, and 14K, and photoconductive cleaners 16Y, 16M, 16C, and 16K.

A laser exposure device 17 irradiates laser beams on the photoconductive drums 12Y, 12M, 12C, and 12K respectively and forms electrostatic latent images on the photoconductive drums 12Y, 12M, 12C, and 12K. The chargers 13Y, 13M, 13C, and 13K and the laser exposure device 17 configure a latent image forming section. The developing devices 14Y, 14M, 14C, and 14K respectively supply toners to the electrostatic latent images on the photoconductive drums 12Y, 12M, 12C, and 12K and visualize the electrostatic latent images.

The printer section 2 includes, above the developing devices 14Y, 14M, 14C, and 14K, toner cartridges 26Y, 26M, 26C, and 26K, which are replacement components, configured to respectively supply toners of Y, M, C, and K to the developing devices 14Y, 14M, 14C, and 14K through sub-hopper units 36Y, 36M, 36C, and 36K. The toner cartridges 26Y, 26M, 26C, and 26K respectively include toner augers 35Y, 35M, 35C, and 35K configured to carry the toners in the directions of the sub-hopper units 36Y, 36M, 36C, and 36K. The toner cartridges 26Y, 26M, 26C, and 26K are mounted on and detached from a cartridge holding section 37 respectively.

A backup roller 20 and a driven roller 21 stretch and suspend the intermediate transfer belt 10. The intermediate transfer belt 10 rotates in an arrow n direction. Primary transfer rollers 18Y, 18M, 18C, and 18K respectively primarily transfer the toner images on the photoconductive drums 12Y, 12M, 12C, and 12K onto the intermediate transfer belt 10. The photoconductive cleaners 16Y, 16M, 16C, and 16K respectively remove and collect residual toners on the photoconductive drums 12Y, 12M, 12C, and 12K after the primary transfer.

The printer section 2 includes a secondary transfer roller 27 opposed to the intermediate transfer belt 10. The printer section 2 secondarily transfers the toner images on the intermediate transfer belt 10 onto the sheet P passing between the intermediate transfer belt 10 and the secondary transfer roller 27. Paper feeding cassettes 7a and 7b or the bypass paper feeding device 8 feeds the sheets P one by one in synchronization with the toner images on the intermediate transfer belt 10. After the secondary transfer finishes, a belt cleaner 10a cleans the intermediate transfer belt 10.

The color copying machine 1 includes, between the paper feeding device 7 and the secondary transfer roller 27, pickup rollers 7e, separation rollers 7c, conveying rollers 7d, and a registration roller pair 28. The color copying machine 1 includes, between a bypass tray 8a of the bypass paper feeding device 8 and the registration roller pair 28, a manual feed pickup roller 8b, a manual feed separation roller 8c, and a manual feed conveying roller 8d. The color copying machine 1 includes, along a conveying direction of the sheet P, a fixing device 30 further downstream than the secondary transfer roller 27.

The color copying machine 1 includes, downstream of the fixing device 30, a gate 33 configured to direct the sheet P in the direction of a paper discharge roller 31 or the direction of a re-conveying unit 32. The color copying machine 1 discharges the sheet P, which reaches the paper discharge roller 31 from the gate 33, onto the paper discharge section 3. The re-conveying unit 32 leads the sheet P in the direction of the secondary transfer roller 27 again.

In the color copying machine 1, when, for example, the toner cartridge 26Y is empty, a user removes the used toner cartridge 26Y from the cartridge holding section 37 and mounts an unused toner cartridge 26Yn for replacement on the cartridge holding section 37. The toner cartridge 26Y is explained below. Although the toner cartridges 26M, 26C, and 26K store toners different from a toner stored in the toner cartridge 26Y, since the structure thereof is the same as the structure of the toner cartridge 26Y, explanation of the toner cartridges 26M, 26C, and 26K is omitted.

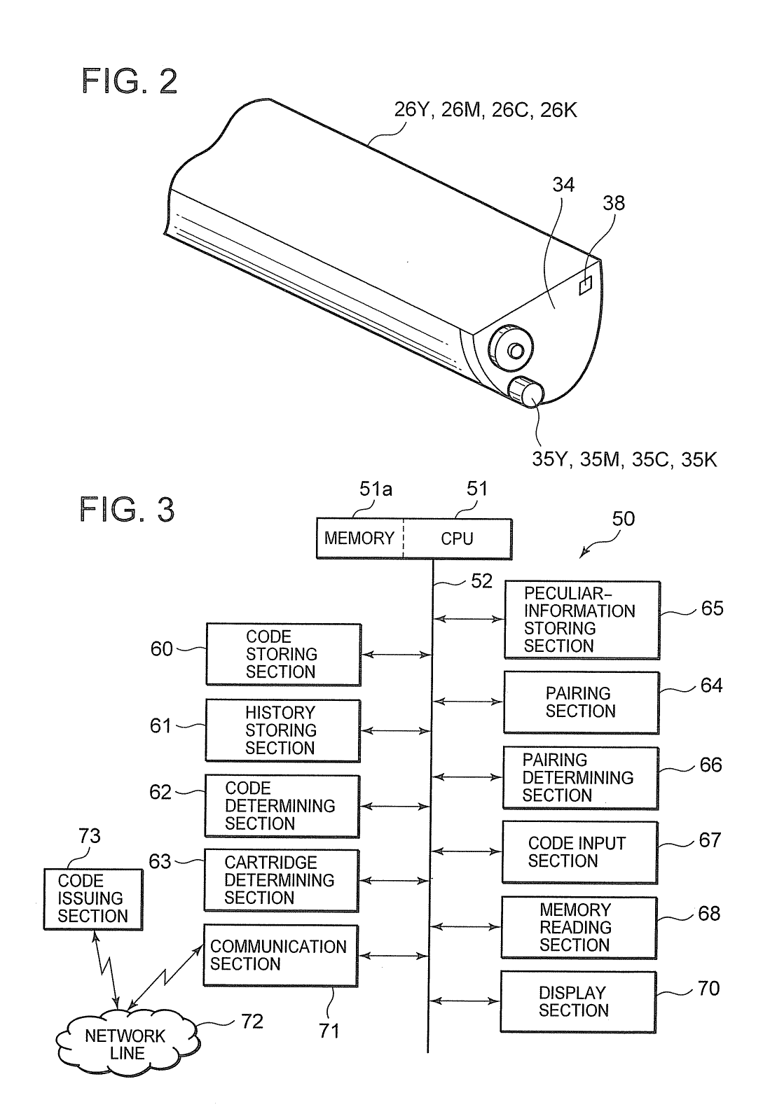

As shown in FIG. 2, the toner cartridge 26Y includes, on an outer wall 34 on the rear side, an IC tag 38 including a nonvolatile memory such as an EEPROM or a Flash ROM. Peculiar information of the toner cartridge 26Y is, for example, a serial number of the toner cartridge 26Y. The peculiar information of the toner cartridge 26Y is information different for each of the toner cartridges.

When the unused toner cartridge 26Yn is mounted on the cartridge holding section 37, the color copying machine 1 determines whether the unused toner cartridge 26Yn is a regular replacement component. A block diagram of a control system 50 configured to mainly determine propriety of the toner cartridge 26Y of the color copying machine 1 is shown in FIG. 3. The control system 50 is the same for the other toner cartridges 26M, 26C, and 26K.

A CPU 51 configured to control the entire color copying machine 1 is connected to a code storing section 60, a history storing section 61, a code determining section 62, a cartridge determining section 63, a pairing section 64, a peculiar-information storing section 65, a pairing determining section 66, a code input section 67, a memory reading section 68, a display section 70, and a communication section 71 via an I/O interface 52. The code storing section 60 stores a valid authentication code of the color copying machine 1 in advance. For example, the valid authentication code is commonly given to machines same as the color copying machine 1. The number of valid authentication codes is not limited to one.

The history storing section 61 stores a serial number of a used toner cartridge that is the peculiar information of the toner cartridge 26Y used by the color copying machine 1 in the past. The CPU 51 reads, with the memory reading section 68, the serial number of the toner cartridge 26Y stored in the IC tag 38 of the toner cartridge 26Y and stores the serial number in the history storing section 61. When the toner cartridge 26Y is mounted on the cartridge holding section 37, the memory reading section 68 reads stored content of the IC tag 38.

The code determining section 62 determines whether a permission authentication code issued by a code issuing section 73 of, for example, a manufacturer, an agent, or a service station of a regular toner cartridge is valid. The permission authentication code refers to a code for enabling the color copying machine 1 to use the unused toner cartridge 26Yn mounted thereon. The user inputs the permission authentication code to a memory 51a of the CPU 51 from the code input section 67 such as a ten key of a control panel or inputs the permission authentication code to the memory 51a from the communication section 71 via a network line 72. The code determining section 62 compares the permission authentication code and the valid authentication code in the code storing section 60. When the permission authentication code and the valid authentication code coincide with each other, the code determining section 62 determines that the permission authentication code is valid.

The cartridge determining section 63 determines whether the unused toner cartridge 26Yn mounted on the cartridge holding section 37 is a regular replacement component. The memory reading section 68 reads a serial number, which is peculiar information of the unused toner cartridge 26Yn, from peculiar information of the unused toner cartridge 26Yn stored in the IC tag 38. The cartridge determining section 63 compares the serial number of the unused toner cartridge 26Yn read by the memory reading section 68 and the serial number of the used toner cartridge stored in the history storing section 61. The cartridge determining section 63 checks the serial number of the unused toner cartridge 26Yn and a enable/disable flag stored in the IC tag 38 of the used toner cartridge 26. If the enable/disable flag is “disabled”, the cartridge determining section 63 determines that the unused toner cartridge 26Yn is a regular replacement component. The cartridge determining section 63 sets a enable/disable flag stored in the IC tag 38 of the unused toner cartridge 26Yn as “enabled”. The toner cartridge replacement work finishes.

When the color copying machine 1, in which the toner replacement finishes, is started, the pairing section 64 writes, if the unused toner cartridge 26Yn is the regular replacement component, the serial number of the unused toner cartridge 26Yn in the peculiar-information storing section 65. The pairing section 64 writes information peculiar to the color copying machine 1 in the IC tag 38 of the toner cartridge 26Y. The color copying machine 1 stores the information peculiar to the color copying machine 1 in the peculiar-information storing section 65 in advance. The information peculiar to the color copying machine 1 is different for each color copying machine 1. If the information peculiar to the color copying machine 1 is, for example, the serial number of the color copying machine 1, the pairing section 64 writes the serial number of the color copying machine 1 in the IC tag 38 of the toner cartridge 26Yn.

For convenience of explanation, a set of the serial number, which is the information peculiar to the color copying machine 1, stored in the peculiar-information storing section 65 in advance by the color copying machine 1 and the serial number of the toner cartridge 26Yn written in the peculiar-information storing section 65 is represented as information (A). A set of the serial number of the color copying machine 1 written in the IC tag 38 and the serial number of the toner cartridge 26Yn of the color copying machine 1 stored in the IC tag 38 in advance is represented as information (B).

The pairing determining section 66 compares the information (A) and the information (B). If the information (A) and the information (B) coincide with each other and the enable/disable flag stored in the IC tag 38 of the toner cartridge 26Yn is “enabled”, the pairing of the color copying machine 1 is completed. The CPU 51 enables the color copying machine 1. If the information (A) and the information (B) do not coincide with each other or if the information (A) and the information (B) coincide with each other but the enable/disable flag stored in the IC tag 38 of the toner cartridge 26Yn is “disabled”, the CPU 51 disables the color copying machine 1.

The display section 70 is, for example, a touch panel of the control panel. The communication section 71 transmits a request for the permission authentication code to the code issuing section 73 via the network line 72 and receives the permission authentication code from the code issuing section 73.

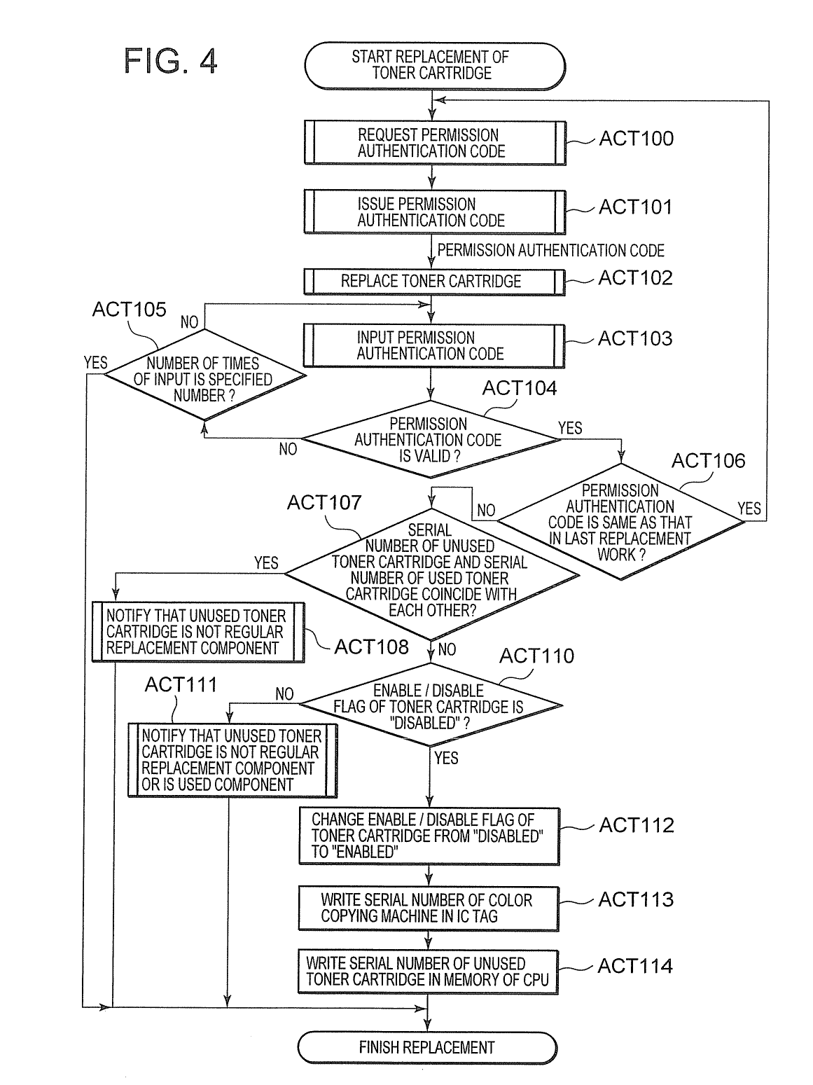

Management for determining whether the unused toner cartridge 26Yn is a regular replacement component is explained with reference to a flowchart shown in FIG. 4. In starting replacement of the toner cartridge 26Y, the user requests the code issuing section 73 to issue a permission authentication code (ACT 100). The user requests the permission authentication code, for example, when the user purchases the unused toner cartridge 26Yn or after the user purchases the unused toner cartridge 26Yn. Time for requesting the permission authentication code is different according to, for example, a form of a maintenance agreement. In ACT 101, the code issuing section 73 issues a permission authentication code.

For example, the user meets a serviceperson face to face or calls the serviceperson to request the code issuing section 73 to issue a permission authentication code and receive the permission authentication code issued by the code issuing section 73. The user who receives the permission authentication code replaces a used toner cartridge with an unused toner cartridge (ACT 102). The user inputs the permission authentication code to the memory 51a from the control panel (ACT 103).

The code determining section 62 determines whether the permission authentication code is valid. The code determining section 62 compares the permission authentication code and the valid authentication code in the storing section 60. If the permission authentication code and the valid authentication code do not coincide with each other, the code determining section 62 determines that the permission authentication code is invalid (No in ACT 104). The color copying machine 1 returns to the ACT 103 and the user inputs the permission authentication code to the memory 51a from the code input section 67 again. However, if the number of times of input of the permission authentication code reaches a specified number of times determined in advance (Yes in ACT 105), the color copying machine 1 finishes replacement work without pairing the unused toner cartridge 26Yn and the color copying machine 1.

If the permission authentication code and the valid authentication code coincide with each other, the code determining section 62 determines that the permission authentication code is valid (Yes in ACT 104) and the color copying machine 1 proceeds to ACT 106. When the color copying machine 1 has plural valid authentication codes, if the permission authentication code input in ACT 103 coincides with the valid authentication code, the color copying machine 1 proceeds to ACT 106. If the permission authentication code is the same as a permission authentication code in the last replacement work (Yes in ACT 106), the color copying machine 1 returns to ACT 100 and the user requests the code issuing section 73 again to issue a permission authentication code. This prevents omission of management of the unused toner cartridge 26Yn that occurs when the user inputs a code used last time without inquiring of the code issuing section 73 about the permission authentication code.

If the permission authentication code is different from the permission authentication code in the last replacement work (No in ACT 106), the color copying machine 1 proceeds to ACT 107. The memory reading section 68 reads the serial number of the unused toner cartridge 26Yn. The cartridge determining section 63 compares the serial number of the unused toner cartridge 26Yn and the serial number of the used toner cartridge of the history storing section 61. If the serial number of the unused toner cartridge 26Yn and the serial number of the used toner cartridge coincide with each other (Yes in ACT 107), the cartridge determining section 63 determines that the unused toner cartridge 26Yn is not the regular replacement component. The CPU 51 displays, on the display section 70, indication that the unused toner cartridge 26Yn is not the regular replacement component (ACT 108). The color copying machine 1 suspends the step for authenticating the unused toner cartridge 26Yn and finishes the replacement work.

If the serial number of the unused toner cartridge 26Yn and the serial number of the used toner cartridge are different (No in ACT 107), the CPU 51 checks the enable/disable flag recorded in the IC tag 38 of the unused toner cartridge 26Yn (ACT 110). If the enable/disable flag is “enabled” (No in ACT 110), the cartridge determining section 63 determines that the unused toner cartridge 26Yn is not the regular replacement component or is a used component. The CPU 51 displays, on the display section 70, indication that the unused toner cartridge 26Yn is not the regular replacement component or is the used component (ACT 111). The color copying machine 1 finishes the replacement work without pairing the unused toner cartridge 26Yn and the color copying machine 1.

If the enable/disable flag is “disabled” in ACT 110 (Yes in ACT 110), the cartridge determining section 63 changes the enable/disable flag from “disabled” to “enabled” (ACT 112). The pairing section 64 writes the serial number of the color copying machine 1 in the IC tag 38 of the toner cartridge 26Yn (ACT 113) and writes the serial number of the unused toner cartridge 26Yn in the peculiar-information storing section 65 (ACT 114). The management performed during the replacement of the toner cartridge 26Y to determine whether the unused toner cartridge 26Yn is the regular replacement component is completed. The toner cartridges 26M, 26C, and 26K are managed in the same manner as the toner cartridge 26Y.

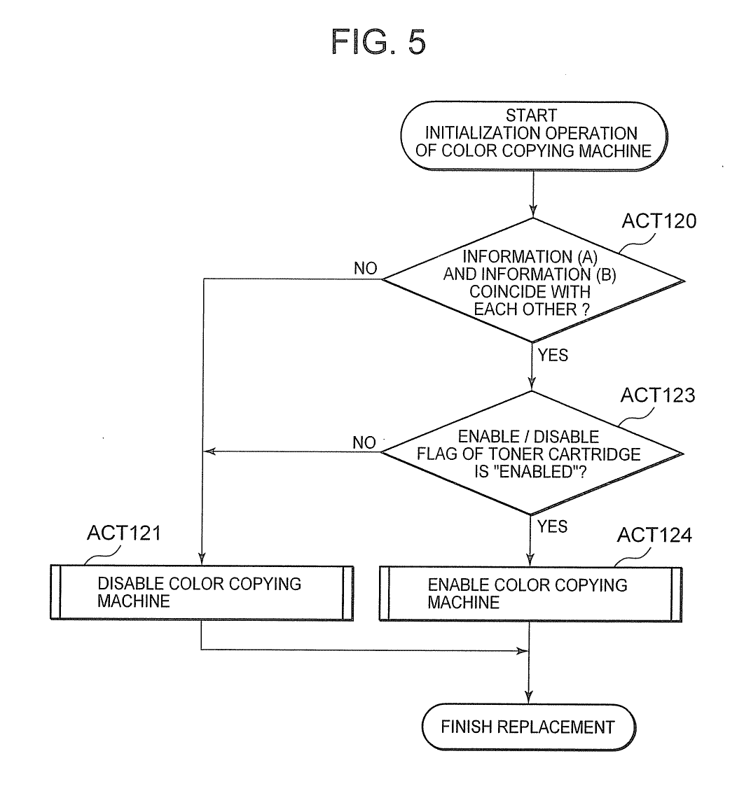

After determining that the unused toner cartridge 26Yn is the regular replacement component and finishing the replacement, the color copying machine 1 checks pairing of the mounted toner cartridge 26Y and the color copying machine 1 during an initialization operation performed, for example, when a power supply is turned on or the color copying machine 1 returns from a sleep mode. Management of the check of the pairing is explained with reference to a flowchart shown in FIG. 5. The pairing is checked to prevent a toner cartridge from being used while being kept replaced with an irregular replacement component halfway in the pairing.

During the start of the initialization operation, the pairing determining section 66 compares information (B) stored in the IC tag 38 of a mounted toner cartridge 26Ys and the information (A) stored by the color copying machine 1 (ACT 120). If the information (B) and the information (A) do not coincide with each other (No in ACT 120), the pairing determining section 66 determines that the mounted toner cartridge 26Ys is not the regular replacement component. The CPU 51 disables the color copying machine 1 (ACT 121).

If the information (B) and the information (A) coincide with each other (Yes in ACT 120), the pairing determining section 66 determines that the mounted toner cartridge 26Ys and the color copying machine 1 are paired and the color copying machine 1 proceeds to ACT 123. In ACT 123, the CPU 51 checks the enable/disable flag recorded in the IC tag 38 of the toner cartridge 26Y. If the enable/disable flag is “disabled” (No in ACT 123), the CPU 51 disables the color copying machine 1 (ACT 121). If the enable/disable flag is “enabled” (Yes in ACT 123), the CPU 51 enables the color copying machine 1 (ACT 124) and finishes the management of the check of pairing during the initialization operation.

In the disablement of the color copying machine 1 in ACT 121, for example, all functions of the color copying machine 1 are disabled. Alternatively, it is also possible to enable a “scan function” and the like in which a toner is not consumed and disable a copy function or a print function in which the toner is consumed.

If the pairing determining section 66 determines in ACT 120 that the mounted toner cartridge 26Ys is not the regular replacement component, for example, the CPU 51 may enable the color copying machine 1 after notifying the user that the mounted toner cartridge 26Ys is not the regular replacement component. A disadvantage due to system down of the color copying machine 1 is prevented. Pairing is managed for the toner cartridges 26M, 26C, and 26K in the same manner as the toner cartridge 26Y.

Thereafter, when the toner cartridge 26Ys mounted in the color copying machine 1 is replaced, the serial number of the mounted toner cartridge 26Ys stored in the peculiar-information storing section 65 is stored in the history storing section 61 as a serial number of a used toner cartridge.

According to the first embodiment, when the toner cartridge 26Y is replaced, if the permission authentication code is not valid, if the unused toner cartridge 26Yn is not the regular replacement component, or if the unused toner cartridge 26Yn is a used component, the color copying machine 1 finishes the replacement work without pairing the unused toner cartridge 26Yn and the color copying machine 1. If the unused toner cartridge 26Yn is determined as the regular replacement component, the color copying machine 1 pairs the color copying machine 1 and the unused toner cartridge 26Yn to allow only a specific color copying machine 1 to use the unused toner cartridge 26Yn.

To use the unused toner cartridge 26Yn as a replacement component, the user has to obtain a valid permission authentication code. An irregular replacement component for which a permission authentication code cannot be obtained is prevented from being distributed in the market. To enable use of the mounted toner cartridge 26Ys in the color copying machine 1, the color copying machine 1 and the mounted toner cartridge 26Ys need to be paired. Even if the irregular replacement component is distributed in the market, it is possible to prevent use of the irregular replacement component that cannot be paired with the color copying machine 1. The distribution of the irregular replacement component in the market is suppressed. The color copying machine 1 is prevented from using the irregular replacement component to obtain a satisfactory print image quality. The use of the irregular replacement component is prevented to prevent a trouble such as a failure of the color copying machine 1.

### SECOND EMBODIMENT

A second embodiment is explained below. The second embodiment is different from the first embodiment in authentication code issuance conditions in the code issuing section 73. In the second embodiment, components same as the components explained in the first embodiment are denoted by the same reference numerals and signs and detailed explanation of the components is omitted.

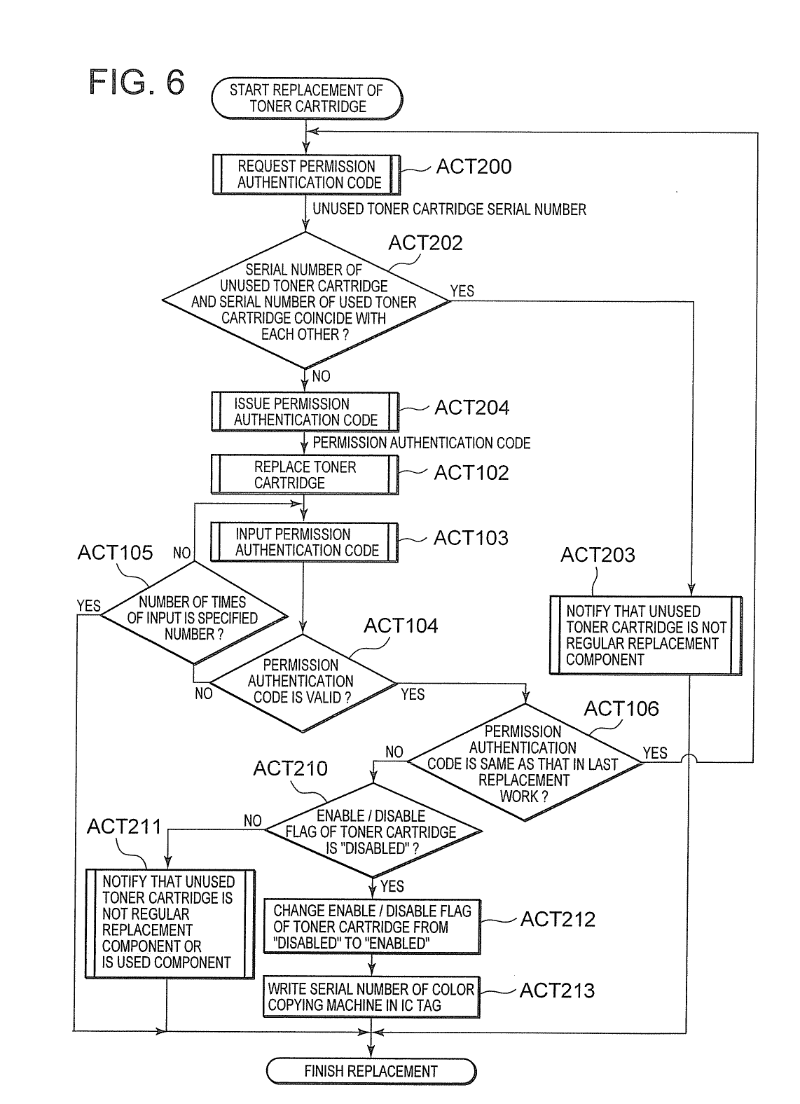

In the second embodiment, the code issuing section 73 does not issue a permission authentication code when the unused toner cartridge 26Yn is an irregular replacement component. Management for determining whether the unused toner cartridge 26Yn is a regular replacement component is explained with reference to a flowchart shown in FIG. 6. In starting replacement of the toner cartridge 26Y, a user notifies the code issuing section 73 of a serial number of the unused toner cartridge 26Yn and requests the code issuing section 73 to issue a permission authentication code (ACT 200).

The code issuing section 73 has recorded therein a serial number of a used toner cartridge used by the color copying machine 1 in the past and notified by the user. The code issuing section 73 compares the serial number of the unused toner cartridge 26Yn notified by the user in ACT 200 and the serial number of the used toner cartridge recorded in the code issuing section 73 and determines whether the serial numbers coincide with each other (ACT 202). If the serial number of the unused toner cartridge 26Yn and the serial number of the used toner cartridge coincide with each other (Yes in ACT 202), the code issuing section 73 does not issue a permission authentication code and notifies the user that the unused toner cartridge 26Yn is not the regular replacement component (ACT 203). Since a permission authentication code is not obtained, the color copying machine 1 finishes replacement work without pairing the unused toner cartridge 26Yn and the color copying machine 1.

If the serial number of the unused toner cartridge 26Yn and the serial number of the used toner cartridge are different (No in ACT 202), the code issuing section 73 issues a permission authentication code and notifies the user of the permission authentication code (ACT 204). The user replaces the used toner cartridge with the unused toner cartridge 26Yn as in the first embodiment (ACT 102) and inputs the permission authentication code to the memory 51a from the control panel (ACT 103). The color copying machine 1 proceeds to ACTS 104 and 106 as in the first embodiment. If the permission authentication code is the same as a permission authentication code in the last replacement work (Yes in ACT 106), the color copying machine 1 returns to ACT 200 and the user requests the code issuing section 73 again to issue a permission authentication code.

If the permission authentication code is different from the permission authentication code in the last replacement work (No in ACT 106), the CPU 51 checks a enable/disable flag of the unused toner cartridge 26Yn (ACT 210). If the enable/disable flag is “enabled” (No in ACT 210), the cartridge determining section 63 determines that the unused toner cartridge 26Yn is not the regular replacement component or is a used component. The CPU 51 displays, on the display section 70, indication that the unused toner cartridge 26Yn is not the regular replacement component or is the used component (ACT 211). The color copying machine 1 finishes the replacement work without pairing the unused toner cartridge 26Yn and the color copying machine 1.

If the enable/disable flag is “disabled” in ACT 210 (Yes in ACT 210), the cartridge determining section 63 changes the enable/disable flag from “disabled” to “enabled” (ACT 212). The pairing section 64 writes a serial number of the color copying machine 1 in the IC tag 38 of the toner cartridge 26Y (ACT 213). The management performed during the replacement of the toner cartridge 26Y to determine whether the unused toner cartridge 26Yn is the regular replacement component is completed. The toner cartridges 26M, 26C, and 26K are managed in the same manner as the toner cartridge 26Y.

Thereafter, the color copying machine 1 checks, during an initialization operation, pairing of the mounted toner cartridge 26Ys and the color copying machine 1 in the same manner as the check shown in FIG. 5 in the first embodiment.

According to the second embodiment, if the unused toner cartridge 26Yn is not the regular replacement component, the code issuing section 73 does not issue a permission authentication code. The color copying machine 1 finishes the replacement work without pairing the unused toner cartridge 26Yn and the color copying machine 1. In the second embodiment, as in the first embodiment, the irregular replacement component is suppressed from being distributed in the market, the irregular replacement component is prevented from being used, and a satisfactory print image quality is obtained and a trouble such as a failure is prevented in the color copying machine 1.

### THIRD EMBODIMENT

A third embodiment is explained below. The third embodiment is different from the second embodiment in authentication code issuance conditions in the code issuing section 73. In the third embodiment, components same as components explained in the second embodiment are denoted by the same reference numerals and signs and detailed explanation of the components is omitted.

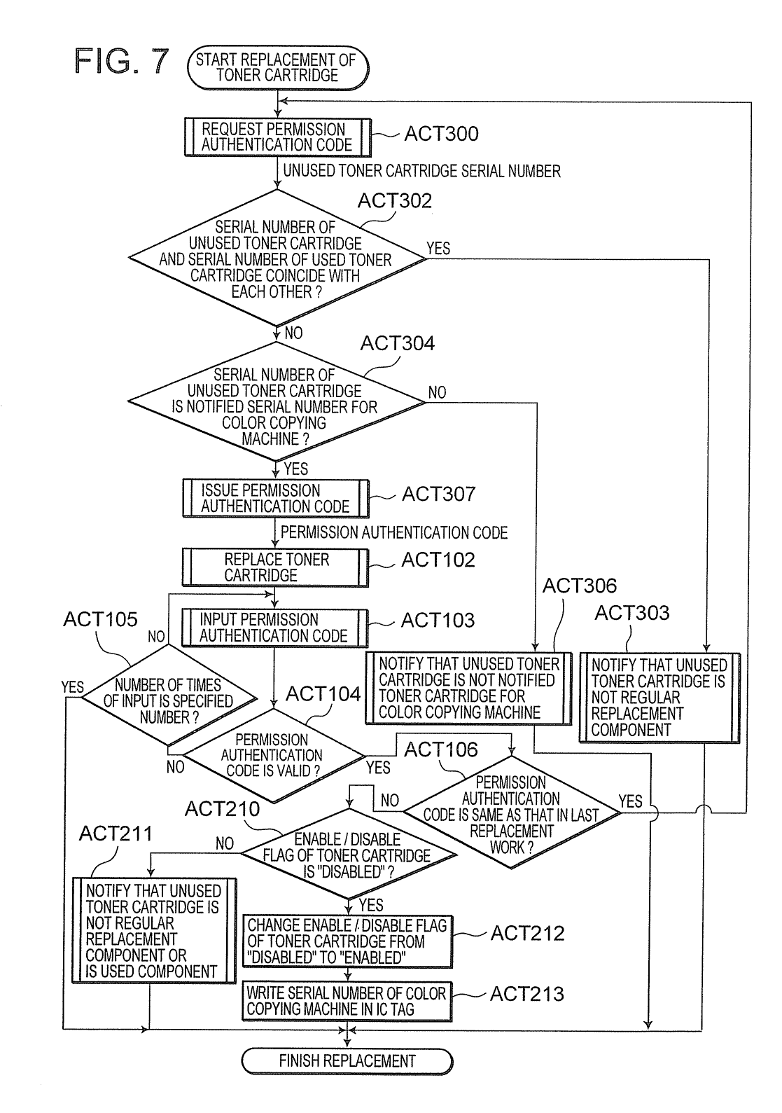

In the third embodiment, the code issuing section 73 does not issue a permission authentication code if the unused toner cartridge 26Yn is an irregular replacement component or if a model to which the unused toner cartridge 26Yn is applied is nonconforming. Management for determining whether the unused toner cartridge 26Yn is a regular replacement component is explained with reference to a flowchart shown in FIG. 7. In starting replacement of the toner cartridge 26Y, a user notifies the code issuing section 73 of a serial number of the unused toner cartridge 26Yn and a serial number that is information peculiar to the color copying machine 1 and requests the code issuing section 73 to issue a permission authentication code (ACT 300).

The code issuing section 73 has recorded therein a serial number of a used toner cartridge used by the color copying machine 1 in the past and notified by the user. The code issuing section 73 compares the serial number of the unused toner cartridge 26Yn notified by the user in ACT 300 and the serial number of the used toner cartridge recorded in the code issuing section 73 and determines whether the serial numbers coincide with each other (ACT 302). If the serial number of the unused toner cartridge 26Yn and the serial number of the used toner cartridge coincide with each other (Yes in ACT 302), the code issuing section 73 notifies the user that the unused toner cartridge 26Yn is not the regular replacement component (ACT 303). Since a permission authentication code is not obtained, the color copying machine 1 finishes replacement work without pairing the unused toner cartridge 26Yn and the color copying machine 1.

If the serial number of the unused toner cartridge 26Yn and the serial number of the used toner cartridge are different (No in ACT 302), the code issuing section 73 determines whether the serial number of the unused toner cartridge 26Yn notified by the user is a serial number for the color copying machine 1 notified by the user (ACT 304). If the serial number of the unused toner cartridge 26Yn is not the serial number for the color copying machine 1 notified by the user (No in ACT 304), the code issuing section 73 notifies the user that the unused toner cartridge 26Yn is not the notified toner cartridge for the color copying machine 1 (ACT 306). Since a permission authentication code is not obtained, the color copying machine 1 suspends a step of authenticating the unused toner cartridge 26Yn and finishes the replacement work.

If the serial number of the unused toner cartridge 26Yn is the notified serial number for the color copying machine 1 (Yes in ACT 304), the code issuing section 73 issues a permission authentication code and notifies the user of the permission authentication code (ACT 307). The user replaces the used toner cartridge with the unused toner cartridge 26Yn as in the second embodiment (ACT 102) and inputs the permission authentication code to the memory 51a from the control panel (ACT 103). The color copying machine 1 executes ACTS 104 and 106 as in the second embodiment.

If the permission authentication code is the same as a permission authentication code in the last replacement work (Yes in ACT 106), the color copying machine 1 returns to ACT 300 and the user requests the code issuing section 73 again to issue a permission authentication code. If the permission authentication code is different from the permission authentication code in the last replacement work (No in ACT 106), the color copying machine 1 executes ACTS 210 to 213. The toner cartridges 26M, 26C, and 26K are managed in the same manner as the toner cartridge 26Y.

Thereafter, the color copying machine 1 checks, during an initialization operation, pairing of the mounted toner cartridge 26Ys and the color copying machine 1 in the same manner as the check shown in FIG. 5 in the first embodiment.

According to the third embodiment, if the unused toner cartridge 26Yn is not the regular replacement component or if the unused toner cartridge 26Yn is not the toner cartridge for the color copying machine 1 of the user, the code issuing section 73 does not issue a permission authentication code. The color copying machine 1 finishes the replacement work without pairing the unused toner cartridge 26Yn and the color copying machine 1. In the third embodiment, as in the second embodiment, the irregular replacement component is suppressed from being distributed in the market, the irregular replacement component is prevented from being used, and a satisfactory print image quality is obtained and a trouble such as a failure is prevented in the color copying machine 1.

### FOURTH EMBODIMENT

A fourth embodiment is explained below. The fourth embodiment is different from the second embodiment in authentication code issuance conditions in the code issuing section 73. In the fourth embodiment, components same as components explained second embodiment are denoted by the same reference numerals and signs and detailed explanation of the components is omitted.

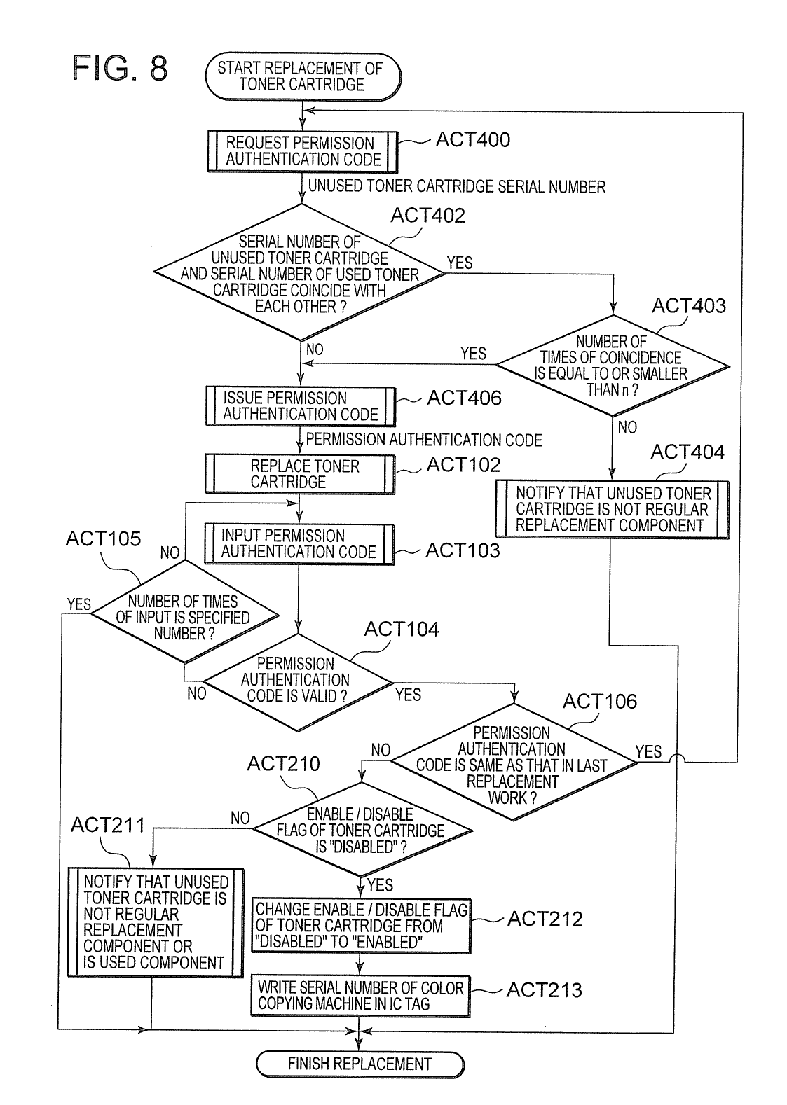

Management for determining whether the unused toner cartridge 26Yn is a regular replacement component is explained with reference to a flowchart shown in FIG. 8. In starting replacement of the toner cartridge 26Y, a user notifies the code issuing section 73 of a serial number of the unused toner cartridge 26Yn and requests the code issuing section 73 to issue a permission authentication code (ACT 400).

The code issuing section 73 compares the serial number of the unused toner cartridge 26Yn notified by the user in ACT 400 and a serial number of a used toner cartridge recorded in the code issuing section 73 and determines whether the serial numbers coincide with each other (ACT 402). If the serial number of the unused toner cartridge 26Yn and the serial number of the used toner cartridge are different (No in ACT 402), the code issuing section 73 issues a permission authentication code and notifies the user of the permission authentication code (ACT 406).

If the serial number of the unused toner cartridge 26Yn and the serial number of the used toner cartridge coincide with each other (Yes in ACT 402), the code issuing section 73 checks whether the number of times of the coincidence is equal to or smaller than n (ACT 403). The code issuing section 73 sets n to, for example, two. When the color copying machine 1 is used for a long period, the code issuing section 73 increases n. When the color copying machine 1 is used for a long period, the code issuing section 73 sets n to, for example, three. If the number of times of coincidence is equal to or smaller than n (Yes in ACT 403), the color copying machine 1 proceeds to ACT 406. If the number of times of coincidence is larger than n (No in ACT 403), the code issuing section 73 notifies the user that the unused toner cartridge 26Yn is not the regular replacement component (ACT 404). Since a permission authentication code is not obtained, the color copying machine 1 finishes replacement work without pairing the unused toner cartridge 26Yn and the color copying machine 1.

When a period of use of the color copying machine 1 is extended, the number of toner cartridges 26Y on sale increases. On the other hand, the number of serial numbers that can be used for the toner cartridges 26Y is limited. When the serial numbers of the toner cartridges 26Y exceed a fixed value, the serial numbers can be repeatedly used from the first serial number. When the period of use of the color copying machine 1 is long, it is likely that even a serial number of the regular unused toner cartridge 26Yn coincides with a used serial number. Even when the serial number of the unused toner cartridge 26Yn and the used serial number coincide with each other, a limit is set for the number of times of coincidence and, if the number of times of coincidence is equal to or smaller than n, the unused toner cartridge 26Yn is determined as a regular replacement component.

The user who receives a permission authentication code in ACT 406 replaces the used toner cartridge with the unused toner cartridge 26Yn as in the second embodiment (ACT 102) and inputs the permission authentication code to the memory 51a from the control panel (ACT 103). The color copying machine 1 executes ACTS 104 and 106 as in the second embodiment.

If the permission authentication code is the same as a permission authentication code in the last replacement work (Yes in ACT 106), the color copying machine 1 returns to ACT 400 and the user requests the code issuing section 73 again to issue a permission authentication code. If the permission authentication code is different from the permission authentication code in the last replacement work (No in ACT 106), the color copying machine 1 executes ACTS 210 to 213. The toner cartridges 26M, 26C, and 26K are managed in the same manner as the toner cartridge 26Y.

Thereafter, the color copying machine 1 checks, during an initialization operation, pairing of the mounted toner cartridge 26Y and the color copying machine 1 in the same manner as the check shown in FIG. 5 in the first embodiment.

According to the fourth embodiment, if a total number of times the serial number of the unused toner cartridge 26Yn and the used serial number coincide with each other exceeds n set in advance, it is determined that the unused toner cartridge 26Yn is the irregular replacement component. The code issuing section 73 does not issue a permission authentication code. The color copying machine 1 suspends a step of authenticating the unused toner cartridge 26Yn and finishes the replacement work. In the fourth embodiment, as in the second embodiment, the irregular replacement component is suppressed from being distributed in the market, the irregular replacement component is prevented from being used, and a satisfactory print image quality is obtained and a trouble such as a failure is prevented in the color copying machine 1.

### FIFTH EMBODIMENT

A fifth embodiment is explained below. The fifth embodiment is different from the first embodiment in a method of requesting and receiving a permission authentication code. In the fifth embodiment, components same as components explained in the first embodiment are denoted by the same reference numerals and signs and detailed explanation of the components is omitted.

In the fifth embodiment, the code issuing section 73 is requested, from the communication section 71 via the network line 72, to issue a permission authentication code. The permission authentication code issued by the code issuing section 73 is received in the communication section 71 via the network line 72 and input to the memory 51a.

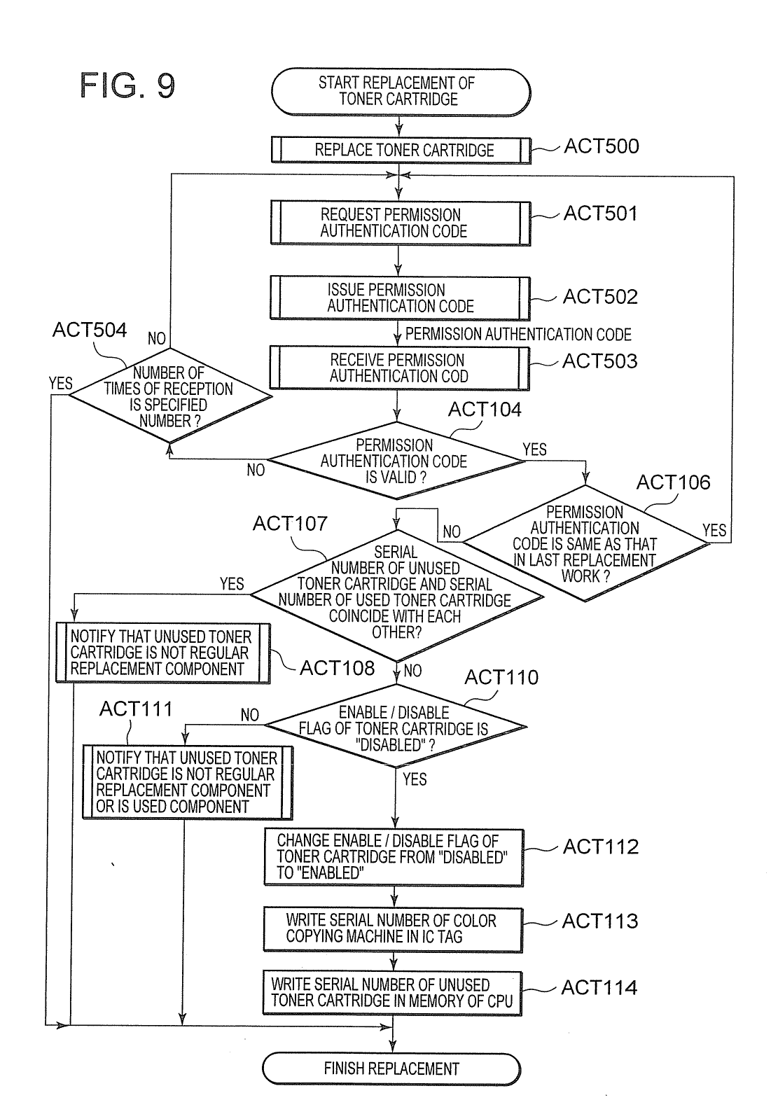

Management for determining whether the unused toner cartridge 26Yn is a regular replacement component is explained with reference to a flowchart shown in FIG. 9. In starting replacement of the toner cartridge 26Y, a user replaces a toner cartridge. The user removes a used toner cartridge from the color copying machine 1 and mounts an unused toner cartridge on the color copying machine 1 (ACT 500). The CPU 51 requests, from the communication section 71 via the network line 72, the code issuing section 73 to issue a permission authentication code (ACT 501)

When the permission authentication code is requested in ACT 501, the code issuing section 73 issues a permission authentication code for the color copying machine 1 (ACT 502). The communication section 71 receives, via the network line 72, the permission authentication code issued by the code issuing section 73 and inputs the permission authentication code to the memory 51a of the CPU 51 (ACT 503). When the permission authentication code is received in ACT 503, the color copying machine 1 proceeds to ACTS 104 and 106 as in the second embodiment.

If the permission authentication code and a valid authentication code do not coincide with each other (No in ACT 104), the color copying machine 1 returns to ACT 501 and the CPU 51 requests the code issuing section 73 again to issue a permission authentication code. If the number of times of reception of the permission authentication code reaches a specified number of times determined in advance (Yes in ACT 504), the color copying machine 1 finishes replacement work without pairing the unused toner cartridge 26Yn and the color copying machine 1. If the permission authentication code is the same as a permission authentication code in the last replacement work (Yes in ACT 106), the color copying machine 1 returns to ACT 501 and the CPU 51 requests the code issuing section 73 again to issue a permission authentication code.

If the permission authentication code is different from the permission authentication code in the last replacement work (No in ACT 106), the color copying machine 1 executes ACTS 107, 108, and 110 to 114 as in the first embodiment. The toner cartridges 26M, 26C, and 26K are managed in the same manner as the toner cartridge 26Y.

Thereafter, during an initialization operation, the color copying machine 1 checks pairing of the mounted toner cartridge 26Ys and the color copying machine 1 in the same manner as the check shown in FIG. 5 in the first embodiment.

According to the fifth embodiment, as in the first embodiment, the irregular replacement component is suppressed from being distributed in the market, the irregular replacement component is prevented from being used, and a satisfactory print image quality is obtained and a trouble such as a failure is prevented in the color copying machine 1. Further, in the fifth embodiment, operation for inputting a permission authentication code by the user is unnecessary.

### SIXTH EMBODIMENT

A sixth embodiment of is explained below. The sixth embodiment is different from the second embodiment in a method of requesting and receiving a permission authentication code. In the sixth embodiment, components same as components explained in the second embodiment are denoted by the same reference numerals and signs and detailed explanation of the components is omitted.

In the sixth embodiment, the code issuing section 73 is requested, from the communication section 71 via the network line 72, to issue a permission authentication code. The permission authentication code issued by the code issuing section 73 is received in the communication section 71 via the network line 72 and input to the memory 51a.

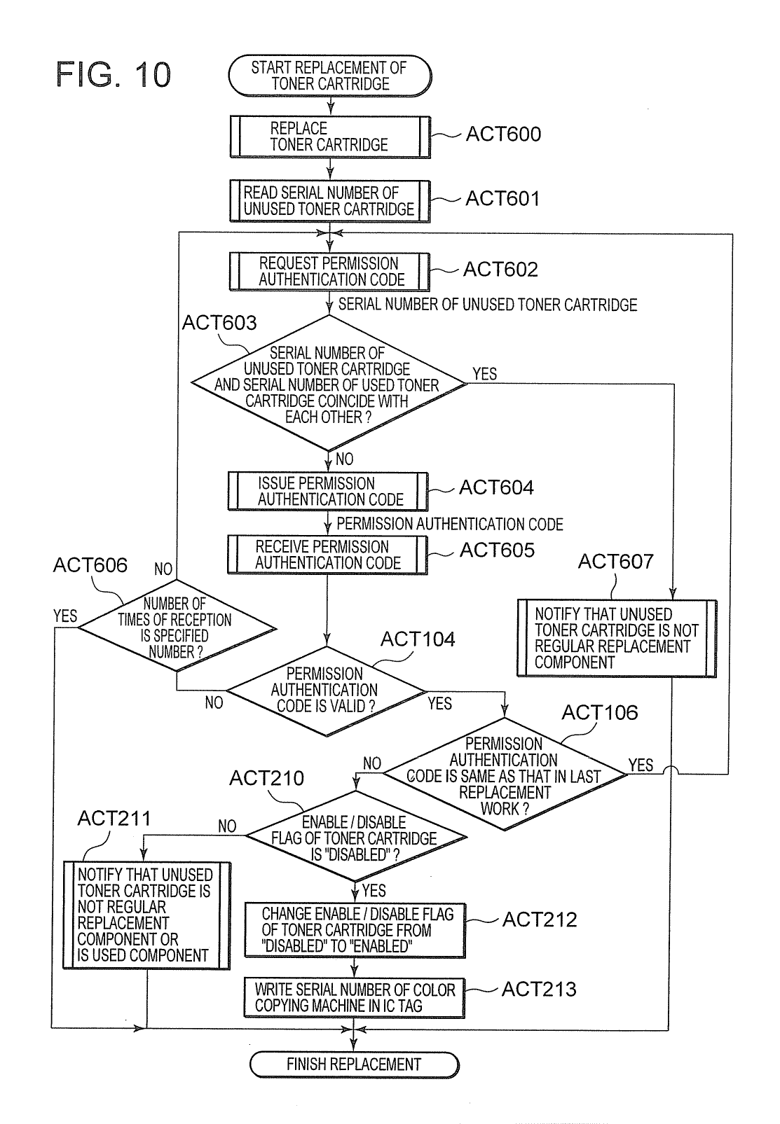

Management for determining whether the unused toner cartridge 26Yn is a regular replacement component is explained with reference to a flowchart shown in FIG. 10. In starting replacement of the toner cartridge 26Y, a user replaces a toner cartridge. The user removes a used toner cartridge from the color copying machine 1 and mounts an unused toner cartridge on the color copying machine 1 (ACT 600). The memory reading section 68 reads a serial number of the unused toner cartridge 26Yn stored in the IC tag 38 of the unused toner cartridge 26Yn (ACT 601).

The CPU 51 transmits, from the communication section 71 via the network line 72, the serial number of the unused toner cartridge 26Yn read in ACT 601 and requests the code issuing section 73 to issue a permission authentication code (ACT 602). When the permission authentication code is requested in ACT 602, the code issuing section 73 compares the transmitted serial number of the unused toner cartridge 26Yn and a serial number of the used toner cartridge 26Y recorded in the code issuing section 73 and determines whether the serial numbers coincide with each other (ACT 603). If the serial number of the unused toner cartridge 26Yn and the serial number of the used toner cartridge 26Y coincide with each other (Yes in ACT 603), the code issuing section 73 does not issue a permission authentication code. The code issuing section 73 notifies, via the network line 72, the color copying machine 1 that the unused toner cartridge 26Yn is not the regular replacement component (ACT 607). Since a permission authentication code is not obtained, the color copying machine 1 finishes the replacement work without pairing the unused toner cartridge 26Yn and the color copying machine 1.

If the serial number of the unused toner cartridge 26Yn and the serial number of the used toner cartridge 26Y are different (No in ACT 603), the code issuing section 73 issues a permission authentication code (ACT 604). The communication section 71 receives, via the network line 72, the permission authentication code issued by the code issuing section 73 and inputs the permission authentication code to the memory 51a of the CPU 51 (ACT 605). When the permission authentication code is received in ACT 605, the color copying machine 1 proceeds to ACTS 104 and 106 as in the first embodiment.

If the permission authentication code and a valid authentication code do not coincide with each other (No in ACT 104), the color copying machine 1 returns to ACT 602 and the CPU 51 requests the code issuing section 73 again to issue a permission authentication code. If the number of times of reception of the permission authentication code reaches a specified number of times determined in advance (Yes in ACT 606), the color copying machine 1 finishes replacement work without pairing the unused toner cartridge 26Yn and the color copying machine 1. If the permission authentication code is the same as a permission authentication code in the last replacement work (Yes in ACT 106), the color copying machine 1 returns to ACT 602 and the CPU 51 requests the code issuing section 73 again to issue a permission authentication code.

If the permission authentication code is different from the permission authentication code in the last replacement work (No in ACT 106), the color copying machine 1 executes ACTS 210 to 213 as in the second embodiment. The toner cartridges 26M, 26C, and 26K are managed in the same manner as the toner cartridge 26Y.

According to the sixth embodiment, as in the second embodiment, the irregular replacement component is suppressed from being distributed in the market, the irregular replacement component is prevented from being used, and a satisfactory print image quality is obtained and a trouble such as a failure is prevented in the color copying machine 1. Further, in the sixth embodiment, operation for inputting a permission authentication code by the user is unnecessary.

### SEVENTH EMBODIMENT

A seventh embodiment is explained. The seventh embodiment is different from the third embodiment in a method of requesting and receiving a permission authentication code. In the seventh embodiment, components same as components explained in the third embodiment are denoted by the same reference numerals and signs and detailed explanation of the components is omitted.

In the seventh embodiment, the code issuing section 73 is requested, from the communication section 71 via the network line 72, to issue a permission authentication code. The permission authentication code issued by the code issuing section 73 is received in the communication section 71 via the network line 72 and input to the memory 51a.

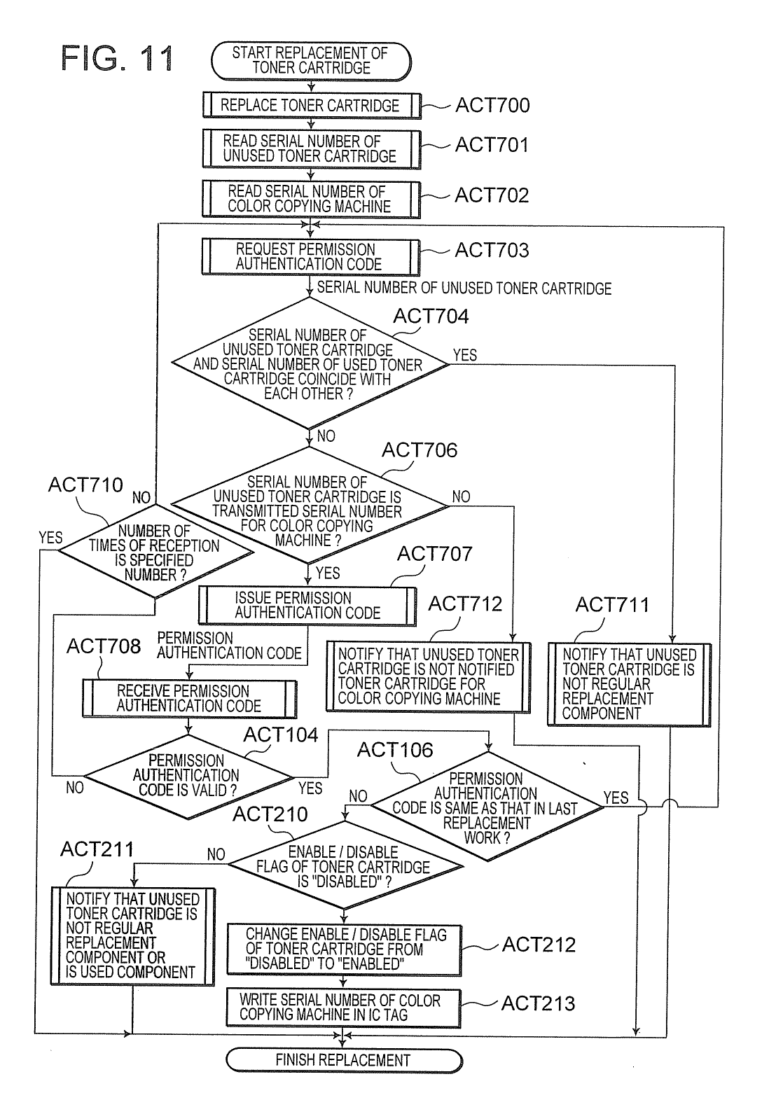

Management for determining whether the unused toner cartridge 26Yn is a regular replacement component is explained with reference to a flowchart shown in FIG. 11. In starting replacement of the toner cartridge 26Y, a user replaces a toner cartridge. The user removes a used toner cartridge from the color copying machine 1 and mounts an unused toner cartridge 26Yn on the color copying machine 1 (ACT 700). The memory reading section 68 reads a serial number of the unused toner cartridge 26Yn stored in the IC tag 38 of the unused toner cartridge 26Yn (ACT 701). The memory reading section 68 reads a serial number that is information peculiar to the color copying machine 1 stored in the peculiar-information storing section 65 (ACT 702).

The CPU 51 transmits, from the communication section 71 via the network line 72, the serial number of the unused toner cartridge 26Yn read in ACT 701 and the serial number read in ACT 702 and requests the code issuing section 73 to issue a permission authentication code (ACT 703). When the permission authentication code is requested in ACT 703, the code issuing section 73 compares the transmitted serial number of the unused toner cartridge 26Yn and a serial number of the used toner cartridge recorded in the code issuing section 73 and determines whether the serial numbers coincide with each other (ACT 704). If the serial number of the unused toner cartridge 26Yn and the serial number of the used toner cartridge coincide with each other (Yes in ACT 704), the code issuing section 73 does not issue a permission authentication code. The code issuing section 73 notifies, via the network line 72, the color copying machine 1 that the unused toner cartridge 26Yn is not the regular replacement component (ACT 711). Since a permission authentication code is not obtained, the color copying machine 1 finishes replacement work without pairing the unused toner cartridge 26Yn and the color copying machine 1.

If the serial number of the unused toner cartridge 26Yn and the serial number of the used toner cartridge are different (No in ACT 704), the code issuing section 73 checks whether the transmitted serial number of the unused toner cartridge 26Yn is a serial number for the color copying machine 1 that requests the permission authentication code (ACT 706). If the serial number of the unused toner cartridge 26Yn is not the serial number for the color copying machine 1 that requests the permission authentication code (No in ACT 706), the code issuing section 73 notifies, via the network line 72, the color copying machine 1 that the unused toner cartridge 26Yn is not a toner cartridge for the color copying machine 1 (ACT 712). Since a permission authentication code is not obtained, the color copying machine 1 finishes the replacement work without pairing the unused toner cartridge 26Yn and the color copying machine 1.

If the serial number of the unused toner cartridge 26Yn is the serial number for the color copying machine 1 that requests the permission authentication code (Yes in ACT 706), the code issuing section 73 issues a permission authentication code (ACT 707). The communication section 71 receives, via the network line 72, the permission authentication code issued by the code issuing section 73 and inputs the permission authentication code to the memory 51a of the CPU 51 (ACT 708). When the permission authentication code is received in ACT 708, the color copying machine 1 proceeds to ACTS 104 and 106 as in the third embodiment.

If the permission authentication code and a valid authentication code do not coincide with each other (No in ACT 104), the color copying machine 1 returns to ACT 703 and the CPU 51 requests the code issuing section 73 again to issue a permission authentication code. If the number of times of reception of the permission authentication code reaches a specified number of times determined in advance (Yes in ACT 710), the color copying machine 1 finishes replacement work without pairing the unused toner cartridge 26Yn and the color copying machine 1. If the permission authentication code is the same as a permission authentication code in the last replacement work (Yes in ACT 106), the color copying machine 1 returns to ACT 703 and the CPU 51 requests the code issuing section 73 again to issue a permission authentication code.

If the permission authentication code is different from the permission authentication code in the last replacement work (No in ACT 106), the color copying machine 1 executes ACTS 210 to 213 as in the third embodiment. The toner cartridges 26M, 26C, and 26K are managed in the same manner as the toner cartridge 26Y.

According to the seventh embodiment, as in the third embodiment, the irregular replacement component is suppressed from being distributed in the market, the irregular replacement component is prevented from being used, and a satisfactory print image quality is obtained and a trouble such as a failure is prevented in the color copying machine 1. Further, in the seventh embodiment, operation for inputting a permission authentication code by the user is unnecessary.

### EIGHTH EMBODIMENT

An eighth embodiment is explained below. The eight embodiment is different from the fourth embodiment in a method of requesting and receiving a permission authentication code. In the eighth embodiment, components same as components explained in the fourth embodiment are denoted by the same reference numerals and signs and detailed explanation of the components is omitted.

In the eighth embodiment, the code issuing section 73 is requested, from the communication section 71 via the network line 72, to issue a permission authentication code. The permission authentication code issued by the code issuing section 73 is received in the communication section 71 via the network line 72 and input to the memory 51a.

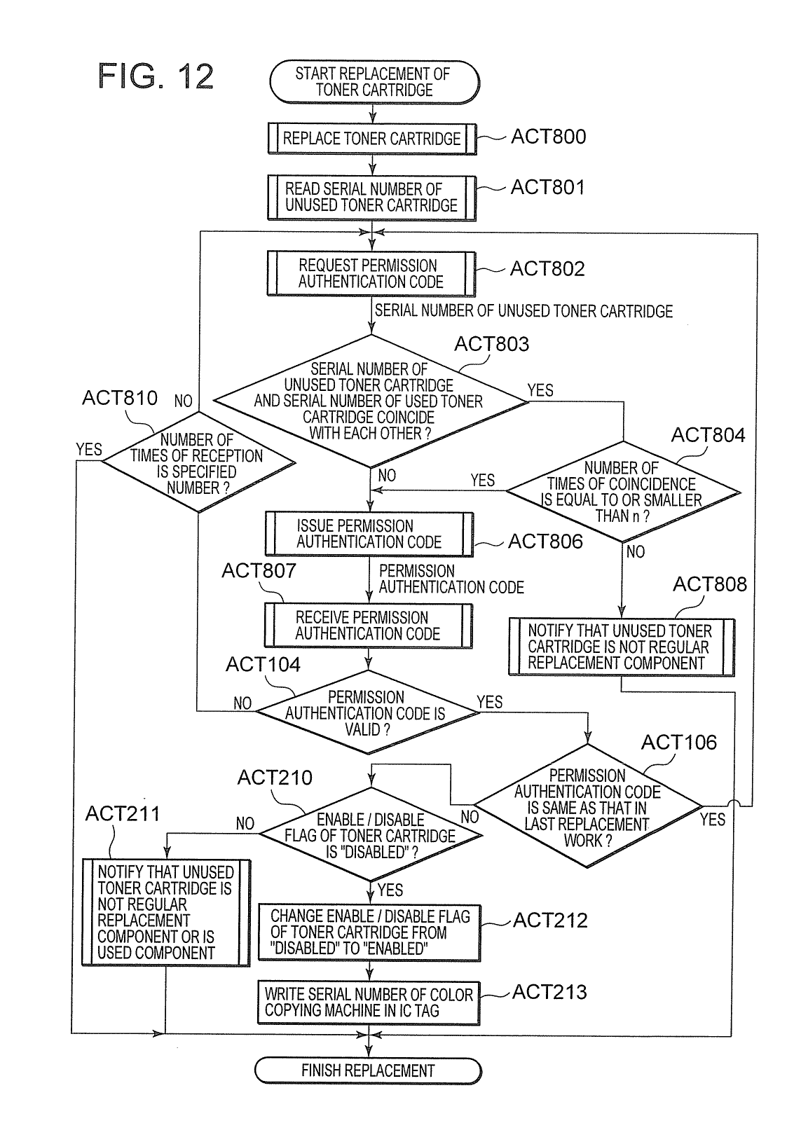

Management for determining whether the unused toner cartridge 26Yn is a regular replacement component is explained with reference to a flowchart shown in FIG. 12. In starting replacement of the toner cartridge 26Y, a user replaces a toner cartridge. The user removes a used toner cartridge from the color copying machine 1 and mounts an unused toner cartridge on the color copying machine 1 (ACT 800). The memory reading section 68 reads a serial number of the unused toner cartridge 26Yn stored in the IC tag 38 of the unused toner cartridge 26Yn (ACT 801).

The CPU 51 transmits, from the communication section 71 via the network line 72, the serial number of the unused toner cartridge 26Yn read in ACT 801 and requests the code issuing section 73 to issue a permission authentication code (ACT 802). When the permission authentication code is requested in ACT 802, the code issuing section 73 compares the transmitted serial number of the unused toner cartridge 26Yn and a serial number of the used toner cartridge recorded in the code issuing section 73 and determines whether the serial numbers coincide with each other (ACT 803). If the serial number of the unused toner cartridge 26Yn and the serial number of the used toner cartridge coincide with each other (Yes in ACT 803), the code issuing section 73 checks whether the number of times of coincidence is equal to or smaller than n (ACT 804).

If the number of times of coincidence is equal to or smaller than n (Yes in ACT 804), the color copying machine 1 proceeds to ACT 806. If the number of times of coincidence is larger than n (No in ACT 804), the code issuing section 73 does not issue a permission authentication code. The code issuing section 73 notifies, via the network line 72, the color copying machine 1 that the unused toner cartridge 26Yn is not the regular replacement component (ACT 808). Since a permission authentication code is not obtained, the color copying machine 1 finishes replacement work without pairing the unused toner cartridge 26Yn and the color copying machine 1. If the number of time of coincidence is equal to or smaller than n (Yes in ACT 804), the code issuing section 73 issues a permission authentication code (ACT 806). The communication section 71 receives, via the network line 72, the permission authentication code issued by the code issuing section 73 and inputs the permission authentication code to the memory 51a of the CPU 51 (ACT 807). When the permission authentication code is received in ACT 807, the color copying machine 1 proceeds to ACTS 104 and 106 as in the fourth embodiment.

If the permission authentication code and a valid authentication code do not coincide with each other (No in ACT 104), the color copying machine 1 returns to ACT 802 and the CPU 51 requests the code issuing section 73 again to issue a permission authentication code. If the number of times of reception of the permission authentication code reaches a specified number of times determined in advance (Yes in ACT 810), the color copying machine 1 finishes replacement work without pairing the unused toner cartridge 26Yn and the color copying machine 1. If the permission authentication code is the same as a permission authentication code in the last replacement work (Yes in ACT 106), the color copying machine 1 returns to ACT 802 and the CPU 51 requests the code issuing section 73 again to issue a permission authentication code.

If the permission authentication code is different from the permission authentication code in the last replacement work (No in ACT 106), the color copying machine 1 executes ACTS 210 to 213 as in the fourth embodiment. The toner cartridges 26M, 26C, and 26K are managed in the same manner as the toner cartridge 26Y.

According to the eighth embodiment, as in the fourth embodiment, the irregular replacement component is suppressed from being distributed in the market, the irregular replacement component is prevented from being used, and a satisfactory print image quality is obtained and a trouble such as a failure is prevented in the color copying machine 1. Further, in the eighth embodiment, operation for inputting a permission authentication code by the user is unnecessary.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

what is claimed is:

1. An image forming apparatus comprising:
a code storing section configured to store a valid authentication code;
a history storing section configured to store peculiar information of a used replacement component;
a code determining section configured to determine, when an unused replacement component is replaced, whether a permission authentication code is valid; and
a cartridge determining section configured to determine whether the unused replacement component is a regular replacement component.

2. The apparatus according to claim 1, further comprising a pairing section configured to store, if the cartridge determining section determines that the unused replacement component is the regular replacement component, unused peculiar information of the unused replacement component in an apparatus main body and store apparatus information of the apparatus main body in a storing section of the unused replacement component.

3. The apparatus according to claim 1, further comprising a pairing determining section configured to determine whether apparatus information stored by a replacement component mounted on an apparatus main body and apparatus information stored by the apparatus main body coincide with each other.

4. The apparatus according to claim 1, further comprising a code input section configured to input the permission authentication code.

5. The apparatus according to claim 1, wherein the code determining section determines, if the permission authentication code coincides with the valid authentication code, that the permission authentication code is valid.

6. The apparatus according to claim 1, wherein the cartridge determining section determines, if peculiar information of the unused replacement component coincides with the peculiar information of the used replacement component, that the unused replacement component is an irregular replacement component.

7. The apparatus according to claim 6, wherein the cartridge determining section determines, if a number of times of coincidence of the peculiar information of the unused replacement component and the peculiar information of the used replacement component exceeds a number of times determined in advance, that the unused replacement component is the irregular replacement component.

8. The apparatus according to claim 1, further comprising a communication section configured to transmit a request for the permission authentication code to the code issuing section and receive the permission authentication code from the code issuing section.

9. The apparatus according to claim 8, wherein the communication section transmits peculiar information of the unused replacement component to the code issuing section together with the request for the permission authentication code.

10. The apparatus according to claim 9, wherein the communication section receives, if the peculiar information of the unused replacement component coincides with peculiar information of a replacement component issued in past, notification that the unused replacement component is irregular from the code issuing section.

11. The apparatus according to claim 8, wherein the communication section transmits peculiar information of the unused replacement component and apparatus information of an apparatus main body to the code issuing section and receives, if a replacement component identified from the peculiar information of the unused replacement component is not a replacement component for the apparatus main body, from the code issuing section, notification that the unused replacement component is a replacement component for a different apparatus.

12. A method of managing a replacement component, comprising:
requesting, when an unused replacement component is replaced, a code issuing section to issue a permission authentication code;
determining whether the permission authentication code issued from the code issuing section is valid; and
determining, if the permission authentication code is determined as valid, whether the unused replacement component is a regular replacement component.

13. The method according to claim 12, further comprising storing, if the unused replacement component is determined as the regular replacement component, peculiar information of the unused replacement component in an apparatus main body and storing apparatus information of the apparatus main body in the unused replacement component.

14. The method according to claim 12, further comprising determining, when a replacement component mounted on an apparatus main body is used, whether apparatus information stored by the mounted replacement component and apparatus information stored by the apparatus main body coincide with each other.

15. The method according to claim 12, further comprising determining, if the permission authentication code coincides with a valid authentication code stored in an apparatus main body, that the permission authentication code is valid.

16. The method according to claim 12, further comprising determining, if peculiar information of the unused replacement component coincides with peculiar information of a used replacement component stored in an apparatus main body, that the unused replacement component is an irregular replacement component.

17. The method according to claim 12, further comprising notifying, in requesting the code issuing section to issue the permission authentication code, the code issuing section of peculiar information of the unused replacement component.

18. The method according to claim 17, wherein, if the peculiar information of the unused replacement component coincides with peculiar information of a replacement component issued in past by the code issuing section, the code issuing section notifies that the unused replacement component is an irregular replacement component.

19. The method according to claim 12, further comprising notifying, in requesting the code issuing section to issue the permission authentication code, the code issuing section of peculiar information of the unused replacement component and information peculiar to an apparatus main body.

20. The method according to claim 19, wherein, if the peculiar information of the unused replacement component is not peculiar information for the apparatus main body, the code issuing section notifies that the unused replacement component is a replacement component for a different apparatus.
